(19) United States
(12) Patent Application Publication
(10) Pub. No.: US 2026/0170645 A1
(43) Pub. Date: Jun. 18, 2026

(54) MEDICAL IMAGE PROCESSING APPARATUS

(71) Applicant: CANON MEDICAL SYSTEMS CORPORATION, Otawara-shi (JP)

(72) Inventor: Zhaoxuan LI, Yokohama (JP)

(73) Assignee: CANON MEDICAL SYSTEMS CORPORATION, Otawara-shi (JP)

(21) Appl. No.: 19/414,380

(22) Filed: Dec. 10, 2025

(30) Foreign Application Priority Data
Dec. 16, 2024 (JP) 2024-219792

(51) Int. Cl. G06T 7/00

(52) U.S. Cl. CPC G06T 7/0012; G06T 2207/10132; G06T 2207/30048

(57) ABSTRACT

A medical image processing apparatus according to an embodiment includes processing circuitry. The processing circuitry is configured to acquire three-dimensional medical image data at a plurality of time phases, extract a temporal feature value of each pixel included in the medical image data, from the medical image data at the plurality of time phases, and estimate an angle of a varying region in the medical image data based on the temporal feature value.

### CROSS-REFERENCE TO RELATED APPLICATIONS

This application is based upon and claims the benefit of priority from Japanese Patent Application No. 2024-219792, filed Dec. 16, 2024, the entire contents of which are incorporated herein by reference.

### FIELD

Embodiments disclosed in the present specification and drawings relate to a medical image processing apparatus.

### BACKGROUND

In medical ultrasonic images, a relative angle of an object in a captured image may change depending on an angle of a probe that is manually operated by a clinician during imaging. For example, transesophageal echocardiography (TEE) is a technique in which an ultrasonic probe is inserted into a patient's esophagus and captures images from the posterior side of the heart. The angle of the ultrasonic probe varies from one imaging to another. In such a case, if separately captured images are simultaneously displayed, the relative angles of the objects in the images differ, making direct comparison difficult. In such situations, adjusting the angles of objects facilitates comparison between objects captured in separate images.

In typical automatic processing, the shape or contour of an object is recognized using techniques such as machine learning, the angle of the object is determined, and then the angle is adjusted to improve visibility.

However, for techniques such as machine learning, it is necessary to perform prior training for a model dedicated to each object. During such prior training, a large amount of computation is required to enable the dedicated model to recognize the object, which is an issue.

### BRIEF DESCRIPTION OF THE DRAWINGS

FIG. 1 is a perspective view illustrating an example of an appearance of an ultrasonic diagnostic apparatus according to a first embodiment;

FIG. 2 is a block diagram illustrating a configuration of the ultrasonic diagnostic apparatus provided with an ultrasonic image processing apparatus according to the first embodiment;

FIG. 3 is a block diagram illustrating functions of the ultrasonic diagnostic apparatus according to the first embodiment;

FIG. 4 is a flowchart illustrating processing to be performed by the ultrasonic diagnostic apparatus according to the first embodiment;

FIG. 5 is a schematic diagram illustrating voxel data, a feature image, and a binarized image according to the first embodiment; and

FIGS. 6A and 6B illustrate examples of original images and images obtained by rotating the original images to a reference angle according to the first embodiment.

### DETAILED DESCRIPTION

A medical image processing apparatus according to an embodiment includes processing circuitry. The processing circuitry is configured to acquire three-dimensional medical image data at a plurality of time phases, extract a temporal feature value of each pixel included in the medical image data, from the medical image data at the plurality of time phases, and estimate an angle of a varying region in the medical image data based on the temporal feature value.

Various Embodiments will be described hereinafter with reference to the accompanying drawings.

### First Embodiment

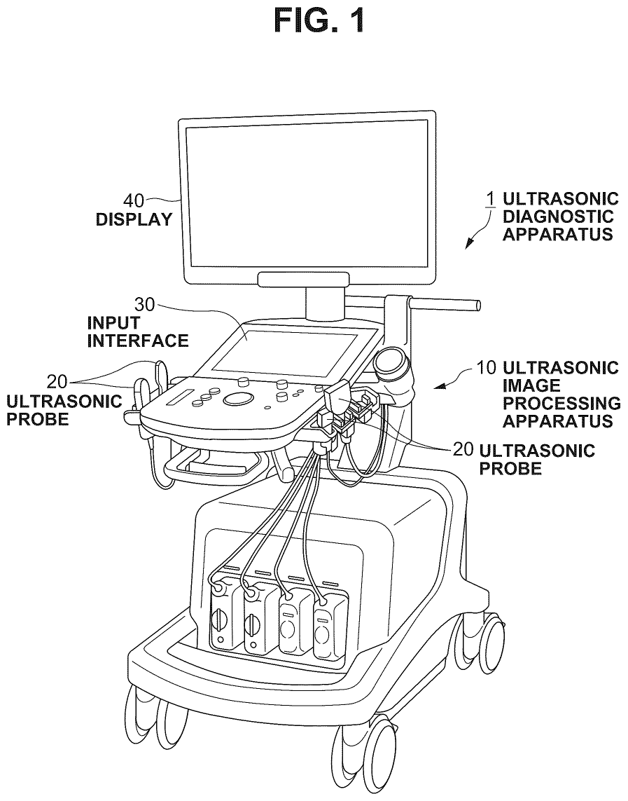

FIG. 1 is a perspective view illustrating an example of an appearance of an ultrasonic diagnostic apparatus 1 according to a first embodiment. As illustrated in FIG. 1, the ultrasonic diagnostic apparatus 1 includes an ultrasonic image processing apparatus 10 and ultrasonic probes 20. The ultrasonic image processing apparatus 10 includes an input interface 30 and a display 40 in addition to various types of circuitry accommodated in a main body case with casters. The ultrasonic image processing apparatus 10 is an example of a medical image processing apparatus.

The input interface 30 is a device that enables a user, through user operations, to input various types of data and information to the ultrasonic image processing apparatus 10 or to set various operation modes on the ultrasonic image processing apparatus 10. The input interface 30 includes two devices, for example, an operation panel and a touch panel.

The operation panel is provided with operation devices such as a trackball, various switches, and dials. The user can input various data and information to the ultrasonic image processing apparatus 10 by operating these operation devices.

The touch panel serves as both a display device and an input device, and includes a touch screen overlaid on a display panel such as a liquid crystal panel. The user can input various types of data and information to the ultrasonic image processing apparatus 10 by touching or pressing the touch screen in accordance with a display on the display panel.

The display 40 displays an ultrasonic image and various types of data generated by various types of circuitry of the ultrasonic image processing apparatus 10. The display 40 includes, for example, a liquid crystal display panel or an organic electroluminescence (EL) panel.

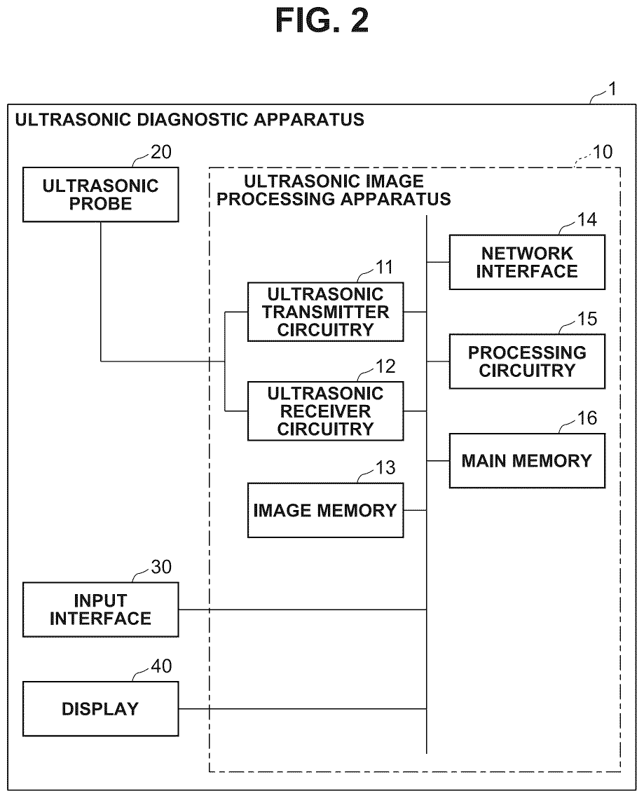

FIG. 2 is a block diagram illustrating a configuration of the ultrasonic diagnostic apparatus 1 provided with the ultrasonic image processing apparatus 10 according to the first embodiment. The ultrasonic image processing apparatus 10 includes ultrasonic transmitter circuitry 11, ultrasonic receiver circuitry 12, an image memory 13, a network interface 14, processing circuitry 15, and a main memory 16. The ultrasonic transmitter circuitry 11 and the ultrasonic receiver circuitry 12 are configured with an application-specific integrated circuit (ASIC) and the like. However, the configuration is not limited to this case, and all or part of the functions of the ultrasonic transmitter circuitry 11 and the ultrasonic receiver circuitry 12 may be implemented by the processing circuitry 15 executing a computer program.

The ultrasonic transmitter circuitry 11 and the ultrasonic receiver circuitry 12 control transmission directivity and reception directivity in transmitting and receiving ultrasonic waves under the control of the processing circuitry 15. A case where both the ultrasonic transmitter circuitry 11 and the ultrasonic receiver circuitry 12 are provided in the ultrasonic image processing apparatus 10 will be described. At least one of the ultrasonic transmitter circuitry 11 and the ultrasonic receiver circuitry 12 may be provided in the respective ultrasonic probes 20 or may be provided in both the ultrasonic image processing apparatus 10 and each ultrasonic probe 20.

The ultrasonic transmitter circuitry 11 includes a function of instantaneously changing a transmission frequency, a transmission drive voltage, and the like in order to execute a predetermined scan sequence based on an instruction from the processing circuitry 15. In particular, the function of changing the transmission drive voltage is implemented by, for example, a linear amplifier type oscillation circuit capable of instantaneously switching its value, or by a mechanism for electrically switching between a plurality of power supply units.

Here, in a case where a three-dimensional (3D) scan, that is, a volume scan is executed, two-dimensional (2D) array probes employing a scanning method such as a linear type, a convex type, a sector type, or the like are used as the ultrasonic probes 20. Alternatively, in a case where a volume scan is executed, one-dimensional (1D) probes employing a scanning method such as a linear type, a convex type, or the like and provided with a mechanism for mechanically swinging in an elevation direction are used as the ultrasonic probes 20. The latter probes are also referred to as mechanical four-dimensional (4D) probes.

The image memory 13 includes, for example, a recording medium readable by a processor, such as a magnetic or optical recording medium, or a semiconductor memory. The image memory 13 stores a plurality of ultrasonic images under the control of the processing circuitry 15.

The network interface 14 implements various information communication protocols corresponding to the form of a network. The network interface 14 may also implement various protocols for contactless wireless communication.

The processing circuitry 15 refers to a dedicated or general-purpose central processing unit (CPU), a microprocessor unit (MPU), or a graphics processing unit (GPU), as well as an ASIC, a programmable logic device, and the like.

The main memory 16 is configured with a semiconductor memory element, such as a random access memory (RAM) and a flash memory, a hard disk, an optical disk, or the like. The main memory 16 may be configured with a portable medium, such as a Universal Serial Bus (USB) memory, a digital versatile disk (DVD), or the like. The main memory 16 stores various processing programs (including application programs and an operating system (OS), among others) used in the processing circuitry 15 and data required for executing the programs.

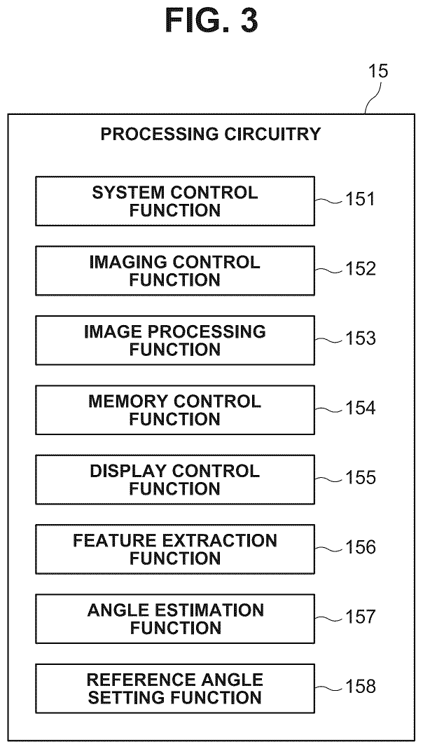

FIG. 3 is a block diagram illustrating functions of the ultrasonic diagnostic apparatus 1. The processing circuitry 15 is a processor that, by calling and executing programs stored in the main memory 16, implements a system control function 151, an imaging control function 152, an image processing function 153, a memory control function 154, a display control function 155, a feature extraction function 156, an angle estimation function 157, and a reference angle setting function 158, as illustrated in FIG. 3. The processing circuitry 15 may be configured by combining a plurality of independent processors, and each processor may execute programs to implement the respective functions.

The system control function 151 includes a function of temporarily storing command signals input by an operator from the input interface 30 and information about various initial setting conditions and the like and then transmitting these pieces of information to each processing function of the processing circuitry 15.

The imaging control function 152 includes, for example, a function of reading information from the system control function 151 and controlling transmission and reception of ultrasonic waves.

The image processing function 153 includes a function of reading image data stored in the image memory 13, performing image processing on the image data, and then storing the image-processed image data back in the image memory 13. The image processing function 153 may also read three-dimensional medical image data (hereinbelow, referred to as “voxel data”) at a plurality of time phases from the image memory 13.

The memory control function 154 includes a function of storing various data in the main memory 16 or reading data from the main memory 16. The memory control function 154 may also read voxel data at a plurality of time phases from the main memory 16.

The display control function 155 includes, for example, a function of reading signals from the system control function 151, acquiring desired ultrasonic image data from the image memory 13, and displaying the ultrasonic image data on the display 40. The display control function 155 may also cause the display 40 to display voxel data in which an angle of a hollow region included in the voxel data has been rotated to a reference angle.

The feature extraction function 156 includes a function of extracting a temporal feature value of each pixel included in voxel data at the plurality of time phases. The voxel data is read out from the image memory 13 or the main memory 16 by the image processing function 153 or the memory control function 154.

The angle estimation function 157 includes a function of estimating the angle of a varying region in the voxel data over the plurality of time phases based on the temporal feature values extracted by the feature extraction function 156.

The reference angle setting function 158 includes a function of setting the reference angle for the voxel data at the plurality of time phases.

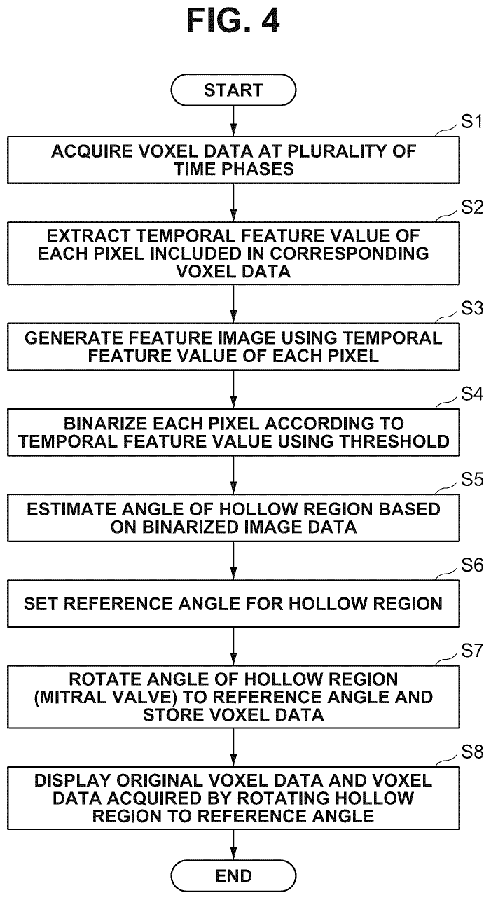

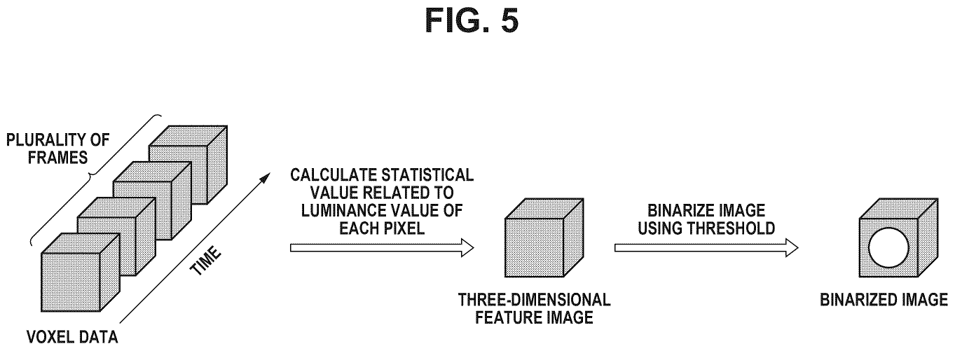

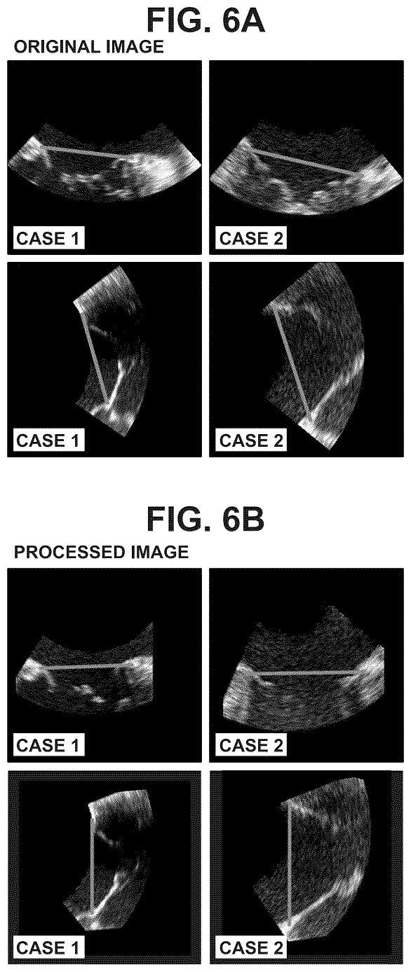

FIG. 4 is a flowchart illustrating a process which is performed by the ultrasonic diagnostic apparatus 1 according to the first embodiment. FIG. 5 is a schematic diagram illustrating voxel data, a feature image, and a binarized image according to the first embodiment. FIG. 6A is a drawing illustrating examples of original images according to the first embodiment. FIG. 6B is a drawing illustrating examples of images obtained by rotating the original images to the reference angle according to the first embodiment.

The varying region indicates a movement of, for example, a mitral valve, a tricuspid valve, or the heart. Among the voxel data, the motion of the varying region is different from the motion of other regions. Thus, it is expected that in each voxel data captured at different times, a change in pixel values in the varying region is large, whereas a change in pixel values in the regions other than the varying region is small or nonexistent. Hereinbelow, angle estimation processing according to the first embodiment will be described according to FIG. 4 with reference to FIGS. 5, 6A, and 6B.

In step S1, the image processing function 153 or the memory control function 154 acquires the voxel data at a plurality of time phases (i.e., four-dimensional image data) from the image memory 13 or the main memory 16. In a case where the image processing function 153 acquires the voxel data from a source other than the image memory 13, the image processing function 153 stores the voxel data in the image memory 13 for saving. An example of voxel data is schematically illustrated on the left side of FIG. 5. Each piece of cubic voxel data includes, for example, three-dimensional data on the heart.

In step S2, the feature extraction function 156 extracts the temporal feature value of each pixel included in the corresponding voxel data at the plurality of time phases acquired in step S1. The feature extraction function 156 may calculate, as the temporal feature value, a statistical value relating to a luminance value of respective pixels located at the same position (coordinates) in the individual pieces of voxel data at the plurality of time phases. The statistical value may be an average, a variance, a standard deviation, and the like.

In step S3, the image processing function 153 generates a feature image using the temporal feature value of each pixel extracted in step S2. The feature image is an image in which the temporal feature of each pixel is reflected in the corresponding pixel. The feature image is, for example, an image in which pixel data representing the color indicated by the luminance value, which is the temporal feature value of each pixel, is arranged at the corresponding pixel position (coordinates) in the voxel data. Thus, if the temporal feature value of each pixel in the voxel data is reflected in the corresponding pixel, the features of each pixel become apparent. An example of a three-dimensional feature image is schematically illustrated in the center of FIG. 5.

In step S4, the image processing function 153 binarizes the pixels according to their respective temporal feature values (e.g., statistical values relating to the luminance value of each pixel) of the feature image generated in step S3 using a predetermined threshold. An example of a binarized image is schematically illustrated in the right side of FIG. 5. For example, the image processing function 153 represents the pixels according to their respective statistical values equal to or greater than the threshold as white, and the pixels according to their respective statistical values less than the threshold as black.

A temporal average value of the pixel luminance values is different between the varying region and a non-varying region, so that binarization can be performed using an appropriate threshold.

Further, it is considered that the variation in the pixel luminance value is large in a varying region and small in a non-varying region. Accordingly, in a case where variance or standard deviation, which indicates a degree of variation in data, is used as the statistical value, a region corresponding to the statistical value greater than or equal to the threshold is a varying region, and a region corresponding to the statistical value less than the threshold is a non-varying region. In this case, the varying regions are represented as white, and the non-varying regions are represented as black in the binarized image.

In step S5, the angle estimation function 157 estimates an angle of a hollow region in the binarized feature image as an angle of the varying region. Specifically, the angle estimation function 157 estimates the angle of the hollow region based on the image data binarized in step S4. If each pixel according to a temporal feature value is binarized the predetermined threshold, the shape of the hollow region becomes apparent, making it possible to estimate the angle of the hollow region.

The angle estimation function 157 estimates the angle of the hollow region based on, for example, geometric features of the hollow region that change regularly over time in the voxel data. The hollow region that changes regularly refers to, for example, a region where valve movement or peristaltic motion of the intestine occurs. A specific portion is an example of such geometric features. FIG. 6A illustrates original images of a mitral valve. The upper row of FIG. 6A illustrates axial plane images of cases 1 and 2, and the lower row of FIG. 6A illustrates sagittal plane images of the cases 1 and 2. To clarify the change before and after a rotation process, a line segment may be drawn connecting points placed in the middle of a range that varies over a plurality of time phases, or a line segment may be drawn connecting points that do not vary over the plurality of time phases.

In step S6, the reference angle setting function 158 sets the reference angle for the hollow region in the voxel data. The reference angle setting function 158 sets the reference angle to, for example, a predetermined direction (e.g., an X-axis direction and a Z-axis direction) in a reference coordinate system in the voxel data. FIG. 6B illustrates images obtained by rotating the original images of the mitral valve to the reference angle. The upper row of FIG. 6B illustrates axial plane images of the cases 1 and 2, and the lower row of FIG. 6B illustrates sagittal plane images of the cases 1 and 2. The reference angle setting function 158 may set the reference angle to an angle specified by a user via the input interface 30.

In step S7, the image processing function 153 rotates the angle of the hollow region (e.g., the mitral valve) in the voxel data to the reference angle set in step S6 and stores the voxel data in the image memory 13.

In step S8, the display control function 155 reads the original voxel data obtained in step S1 and the voxel data obtained by rotating the angle of the hollow region to the reference angle in step S7 from the image memory 13 and displays them on the display 40.

According to the above-described technique, instead of recognizing an object itself, such as a valve, from an ultrasonic image and estimating the angle of the object, the angle of a feature portion extracted from the ultrasonic image is estimated, thus realizing real-time processing. Next, compared with a conventional method based on machine learning, a calculation amount is significantly reduced because prior model training and object recognition are unnecessary. Further, the above-described technique can be used as general-purpose means rather than dedicated means for a specific object.

According to at least one of the above-described embodiments, the angle of an object in medical image data can be estimated without a large amount of calculation.

The image processing function 153 and the memory control function 154 are examples of an acquisition unit. The feature extraction function 156 is an example of an extraction unit. The angle estimation function 157 is an example of an estimation unit. The reference angle setting function 158 is an example of a setting unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical image processing apparatus comprising processing circuitry configured to:
acquire three-dimensional medical image data at a plurality of time phases;
extract a temporal feature value of each pixel included in the medical image data, from the medical image data at the plurality of time phases; and
estimate an angle of a varying region in the medical image data based on the temporal feature value.

2. The medical image processing apparatus according to claim 1, wherein the processing circuitry is configured to estimate an angle of a hollow region in the medical image data as an angle of the varying region, based on the temporal feature value.

3. The medical image processing apparatus according to claim 2, wherein the processing circuitry is configured to:
set a reference angle for the medical image data; and
display, on a display unit, the medical image data in which the angle of the hollow region is rotated to the reference angle.

4. The medical image processing apparatus according to claim 2, wherein the processing circuitry is configured to estimate the angle of the hollow region based on a specific portion of the hollow region that changes regularly over time in the medical image data.

5. The medical image processing apparatus according to claim 2, wherein the processing circuitry is configured to:
calculate a statistical value relating to a luminance value of each pixel included in the medical image data at the plurality of time phases as the temporal feature value;
binarize a pixel according to the statistical value using a predetermined threshold; and
estimate the angle of the hollow region based on image data in which the pixel is binarized.

6. The medical image processing apparatus according to claim 1, wherein the varying region indicates a movement of a mitral valve, a tricuspid valve, or a heart.
